(19) United States
(12) Patent Application Publication
(10) Pub. No.: US 2007/0117581 A1
(43) Pub. Date: May 24, 2007

(54) Systems and methods for providing push-to-talk to full-duplex voice internetworking

(76) Inventors: Frank Chu, Cupertino, CA (US); Corey Gates, Belmont, CA (US); Virgil Dobjanschi, Dublin, CA (US); Chris DeCenzo, San Francisco, CA (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/594,366

(22) Filed: Nov. 7, 2006

Related U.S. Application Data
(60) Provisional application No. 60/734,451, filed on Nov. 7, 2005.

(51) Int. Cl. H04B 7/00; H04Q 7/20

(52) U.S. Cl. 455/518

(57) ABSTRACT

Systems and methods for enabling a PTT user to communicate with an FDV user on a personal PTT communication appliance are provided. The PTT user communicates with the FDV user by connecting to a PTT to FDV system associated with a PTT network and a FDV network. The PTT to FDV system allows users on both PTT and full-duplex networks to communicate rapidly, efficiently, without requiring change in user behavior, without unnecessary speech cutoff, and without requiring technology modifications on either network.

### CROSS REFERENCE TO RELATED APPLICATIONS

This Application claims the benefit of and priority to U.S. Provisional Patent Application Ser. No. 60/734,451 titled “System and Method for Providing Push-to-Talk to Full-Duplex Voice Internetworking” filed on Nov. 7, 2005, the entire disclosure of which is hereby incorporated by reference.

### FIELD OF THE INVENTION

The present invention relates generally to systems and methods for providing communication between a push-to-talk network and a full-duplex voice network. In particular, the systems and methods of the present invention provide the user of a push-to-talk network the ability to communicate with a user of a full-duplex voice network.

### BACKGROUND OF THE INVENTION

Advances in communication networks have enabled the development of powerful and flexible information distribution technologies. Users are no longer tied to the basic newspaper, television and radio distribution formats and their respective schedules to receive their voice, written, auditory, or visual information. Information can now be streamed or delivered directly to computer desktops, laptops, digital music players, personal digital assistants (“PDAs”), wireless telephones, and other communication appliances, providing virtually unlimited information access to users.

The fastest way to convey information on a personal communication appliance (such as wireless telephones and PDAs) is by using a push-to-talk (“PTT”) service. Such service is provided by a PTT service provider, including Sprint Nextel, of Reston, Va., with its Nextel Direct Connect service. A PTT service operates as a walkie-talkie service, in that it can only be used as an effective and rapid person-to-person or group voice communication tool. By pressing a PTT button on the communication appliance, PTT users can set up a call with remote parties much faster than traditional phone calls, thereby saving valuable time and improve productivity.

A PTT service is inherently a half-duplex model of communication. That is, when one user is pushing the PTT button to talk to another user, the recipient cannot talk back at the same time. As long as the PTT button is being held by the user, the user can talk but cannot hear the recipient. The user must release the PTT button to receive information from the recipient. That is, voice communication flows in only one direction at a time.

As a result, PTT users cannot have traditional voice conversations in which two people communicate simultaneously. PTT users also do not have access to the vast amount of information that can be delivered to personal communication appliances on traditional full-duplex voice (“FDV”) networks, which are capable of transmitting information in both directions simultaneously. An example of a FDV network is the public switched telephone network (“PSTN”).

In particular, users of FDV networks can access information with their personal communication appliances (such as wireless telephones and PDAs) using a number of information access tools, including an interactive voice response (“IVR”) system that allows the user to access, retrieve, and even provide information on the fly using simple touch button or speech interfaces.

An IVR system enables a user to call an address on the FDV network and receive information by interacting with the system with user inputs. For example, a user may call a telephone number corresponding to an IVR system for making airline ticket reservations with a particular airline. The IVR system may guide the user to access and provide information relating to the airline ticket reservation by querying the user for user inputs and generating custom responses based on the user inputs. In another example, a user may call a telephone number corresponding to an IVR system for buying movie tickets and navigate a user menu to decide which movie to buy tickets for.

In general, PTT networks and FDV networks are separate and not connected. The services of one network are not available to the other. IVR systems, for example, are only available to users of FDV networks.

To address the inherent half-duplex limitations of PTT networks, techniques for providing full-duplex communication capabilities for users of half-duplex systems have been developed. For example, U.S. Pat. No. 6,563,804 describes a system and a method for providing full-duplex audio communication utilizing a half-duplex audio circuit, such as an audio card in a personal computer.

And U.S. Patent Publication No. 2003/0224825 describes a communication system for permitting communications between a PTT network and a FDV network by means of a specially-configured gateway. The gateway enables a user of a FDV network to communicate with a user of a PTT network by having the FDV network user emulate a PTT session on his communication device. The FDV network user emulates a PTT session by pressing and depressing special keys on the communication device, such as DTMF digits on a telephone. The keys pressed act as a PTT button on the full-duplex communication device so that the FDV network user is able to communicate with the PTT network user by pressing and depressing the keys, much like a PTT network user would do to communicate using a PTT device.

However, while the gateway allows a FDV network user to communicate with a PTT network user, it does not allow a FDV network user to communicate at will without first pressing a key. The FDV network user may not, for example, communicate simultaneously with the PTT network user without the key press. That is, the FDV network user cannot engage in a conversation with the PTT network user in the same way that he normally would to communicate with another FDV network user. Furthermore, the gateway does not allow a PTT network user to use an IVR system on a FDV network without the IVR system being configured to send out-of-band signals to initiate a communication session, similar to the DTMF keys that need to be pressed by an FDV network user when communicating with a PTT network user.

Thus, there is a need to provide systems and methods for enabling a user in a PTT network to connect to a user in a FDV network and vice-versa by communicating rapidly, efficiently, and without requiring additional user interactions.

There is also a need to allow users on a PTT network to connect to IVR systems and other information access tools on a FDV network rapidly, efficiently, and without requiring additional user interactions.

### BRIEF SUMMARY OF THE INVENTION

In view of the foregoing, a general object of the present invention is to provide systems and methods for enabling a user in a PTT network to connect to a user or IVR system in FDV network.

In one aspect, the present invention provides systems and methods for providing a user in a PTT network connection to a user in a FDV network rapidly, efficiently, without requiring change in user behavior, without unnecessary speech cutoff, and without requiring technology modifications on either network. The present invention significantly improves user experience in a full-duplex to push-to-talk conversation by enabling users/systems on both sides to behave as if the remote end is using the same technology.

For example, an FDV network user can speak at will without requiring additional interactions such as pressing a key to speak or being told to stop speaking when the PTT network user is engaged to communicate with the FDV network user, i.e., when the PTT network user “has the floor” by a press of the PTT button in his PTT communication appliance. Similarly, a PTT network user can press the PTT button and speak per his/her normal behavior. This interaction can be achieved without unnecessary cutoff of speech from the FDV network while the PTT network user has the floor. Furthermore, no modifications in the PTT or the FDV networks are required in order to adapt the existing PTT and FDV networks to interface with the system of the present invention.

In another aspect, the present invention provides systems and methods for delivering IVR services hosted on a FDV network to users on a PTT network. Accordingly, PTT users may connect to an IVR system or other information access tool on a FDV network and interact with the IVR system to access information provided by the IVR system, or conversely, to provide information to the IVR system.

These and other aspects of the present invention are accomplished by using an exemplary embodiment of a PTT to FDV communication system. The PTT to FDV communication system enables PTT users to connect to an FDV user or to an IVR system hosted in the FDV network rapidly, efficiently, and without requiring additional user interactions via a simple push of a PTT button provided on a PTT communication appliance. By pressing the PTT button, the PTT user will connect to an FDV user or to an IVR system hosted in the FDV network. Conversely, the PTT to FDV communication system enables FDV users to connect to PTT users for the purposes of simultaneous communication in full-duplex mode.

In an exemplary embodiment, the PTT to FDV communication system includes: (1) a PTT to FDV server component; (2) an interface between the PTT to FDV server component and the PTT communication network; and (3) an interface between the PTT to FDV server component and the FDV communication network.

The PTT to FDV communication system may work in conjunction with any combination of PTT and FDV networks, independent of the technology used by the PTT or FDV service providers. The PTT to FDV system communication system may run along the side or within either the PTT or FDV networks and can send call signaling and media appropriate to the particular technologies used.

In some embodiments a system for providing communication between a user on a PTT communication appliance equipped to connect to a PTT network and a user on an full-duplex communications network is provided, the system comprising: a server for connecting the user on the PTT network to the user on the full-duplex network and for providing full-duplex communication between the user on the PTT network and the user on the full-duplex network without requiring change in user behavior, unnecessary speech cutoff and technology modifications on either network; an interface for communication between the server and the PTT network; and an interface for communication between the server and the FDV network.

In other embodiments, a system for providing communication between a user on a PTT communication appliance equipped to connect to a PTT network and an information access tool available to users on a full-duplex communications network is provided, the system comprising: a server for connecting the user on the PTT network to the information access tool on the full-duplex network and for providing full-duplex communication between the user on the PTT network and the information access tool on the full-duplex network without requiring change in user behavior, unnecessary speech cutoff and technology modifications on either network; an interface for communication between the server and the PTT network; and an interface for communication between the server and the FDV network.

In another aspect, embodiments of the present invention provide a method for providing full-duplex communication capabilities to a user on a communication appliance equipped to connect to a PTT network, the method comprising connecting the user on the PTT network to a user on a full-duplex network without requiring change in user behavior, unnecessary speech cutoff and technology modifications on either network.

In further embodiments, an information server for providing full-duplex communication capabilities to a user on a communication appliance equipped to connect to a PTT network is provided, the server configured to connect the user on the PTT network to a user on a full-duplex network without requiring change in user behavior, unnecessary speech cutoff and technology modifications on either network.

Advantageously, the systems and methods of the present invention enable simultaneous communication between PTT network users and FDV network users in a rapid and efficient manner, without requiring technology modifications to the PTT and FDV networks and without any additional user interactions, such as the pressing of a key by the FDV network user prior to communicating with the PTT network user. Further, the systems and methods of the present invention enable PTT network users to access IVR systems or other information access tools available to FDV network users in an FDV network.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 shows an exemplary schematic diagram of a PTT to FDV system in accordance with the principles and embodiments of the present invention;

FIG. 2 shows an exemplary call flow involving interactions between a PTT user, a PTT to FDV server, and a FDV user; and

FIG. 3 shows another exemplary call flow involving interactions between a PTT user, a PTT to FDV server, and a FDV IVR system.

### DETAILED DESCRIPTION OF EMBODIMENTS OF THE INVENTION

Generally, in accordance with exemplary embodiments of the present invention, a system and methods are provided for PTT network users using PTT personal communication appliances to connect to FDV network users using FDV personal communication appliances or to connect to IVR systems or other information access tools available to the FDV network users rapidly, efficiently, and without requiring additional user interactions or technology modifications to the PTT and FDV networks. As used herein, PTT personal communication appliances refer to any communication appliance equipped with a PTT button, such as wireless telephones, PDAs, among others. A PTT button refers to a button or other interface tool available on the personal communication appliance for connecting to a PTT communications network. As used herein, FDV personal communication appliances refer to any communication appliance equipped for full-duplex voice communications, such as wireless telephones, PDAs, among others.

A PTT user is identifiable in the PTT network by a network address, which may include, but is not limited to, a public switch telephone number, an IP address, a Universal Resource Identifier (“URI”), or other private number plan such as Universal Fleet Member Identifier (“UFMI”).

Similarly, a FDV user or FDV IVR system is identifiable in the FDV network by a network address, which may include, but is not limited to, a public switch telephone number, an IP address, a Universal Resource Identifier (“URI”), or other private number plan.

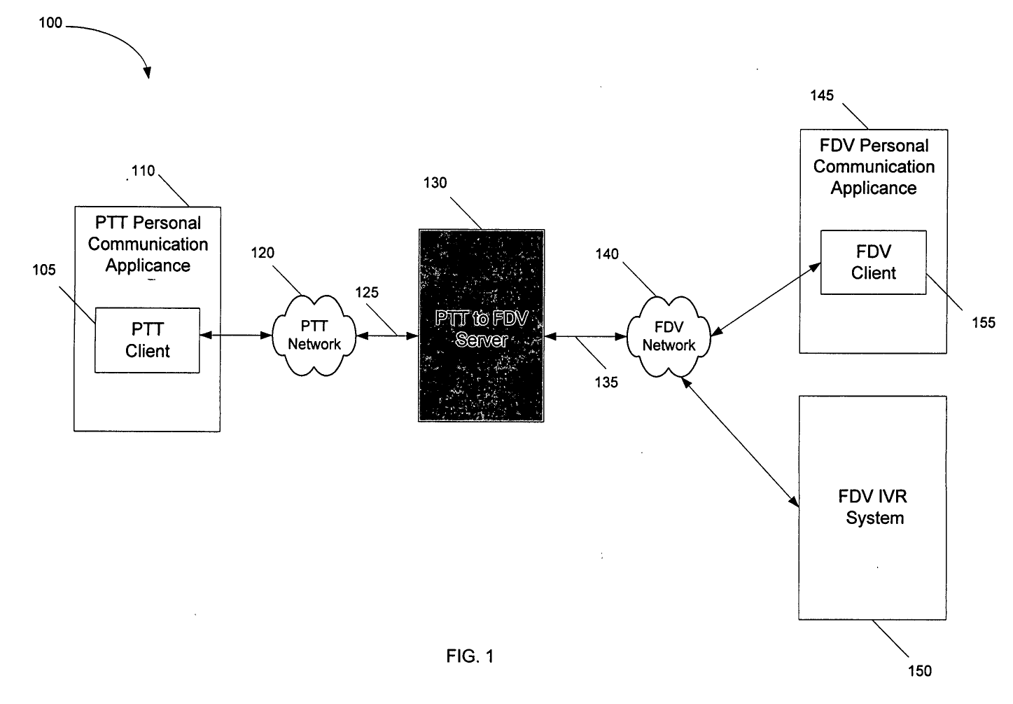

Referring to FIG. 1, an exemplary schematic diagram of a PTT to FDV system in accordance with the principles and embodiments of the present invention is provided. A PTT user may connect to an FDV user or to an FDV IVR system via PTT network 120 by using PTT to FDV system 100 on PTT personal communication appliance 110. An FDV user may connect to a PTT user via FDV network 140 by using PTT to FDV system 100 on FDV personal communication appliance 145. Similarly, FDV IVR system 150 may be connected to a PTT user via FDV network 140 by using PTT to FDV system 100.

PTT to FDV system 100 may include the following components: (1) PTT to FDV server component 130; (3) interface 125 between PTT to FDV server component 130 and PTT communications network 120; and (4) interface 135 between PTT to FDV server component 130 and FDV communications network 140. PTT to FDV system 100 may also include FDV client 155 on FDV personal communication appliance 145 and PTT client 105 on PTT personal communication appliance 110 for communicating to PTT to FDV server component 130. PTT client 105 provides PTT services on PTT personal communication appliance 110. PTT personal communication appliance 110 may support more than one type of PTT client 105.

PTT to FDV Server Component

PTT to FDV server component 130 may be configured to perform one or more tasks. PTT to FDV server component 130 may be configured to initiate and terminate PTT call signaling and media streams as well as initiate and terminate FDV call signaling and media streams.

Further, PTT to FDV server component 130 may maintain states for a call session such that subsequent PTT presses may allow for additional communication between the PTT user and the FDV user or IVR system. A session may involve multiple PTT calls, each with one or more PTT presses.

During the course of a PTT to FDV communication session, PTT to FDV server component 130 detects when a user or system in FDV network 140 is speaking. PTT to FDV server component 130 then attempts to send voice to the PTT user of PTT personal communication appliance 110. If the PTT user is currently speaking, PTT to FDV server component 130 may either place the voice in a buffer until the PTT user is no longer speaking, or in case the buffer may become full, discard a portion of or the entire voice at a small cost of speech cutoff. As understood by one of ordinary skill in the art, the size of the buffer may be made big enough to prevent voice from ever being discarded.

Similarly, during the course of a PTT to FDV IVR system (or other information access tool) communication session where FDV IVR system 150 is expecting the PTT user to press a key before continuing, i.e., expecting DTMF input, so that the PTT user can, for example, make a selection in an IVR menu, PTT to FDV server component 130 may generate a pre-defined DTMF tone to FDV IVR system 150 whenever the PTT user has pressed and released the PTT button on PTT personal communication appliance 110.

One example of this usage scenario is when FDV IVR system 150 needs PTT user input to select an option in an IVR menu, such as, “please press the PTT button if you want to hear more information.” Upon the PTT user pressing the PTT button on PTT personal communication appliance 110, PTT to FDV server component 130 may then generate a pre-defined DTMF tone to FDV IVR system 150 so that FDV IVR system 150 can process the PTT user input.

PTT to FDV System Interfaces

Various system interfaces are provided within PTT to FDV system 100, including: (1) interface 125 between PTT to FDV server component 130 and PTT network 120; and (2) interface 135 between PTT to FDV server component 130 and FDV network 140.

Interface 125 between PTT to FDV server component 130 and PTT network 120 may be implemented with standard industry protocols, such as 3GPP PoC. Interface 135 between PTT to FDV server component 130 and FDV network 140 may be implemented with standard industry protocols, such as SIP.

Call Flows

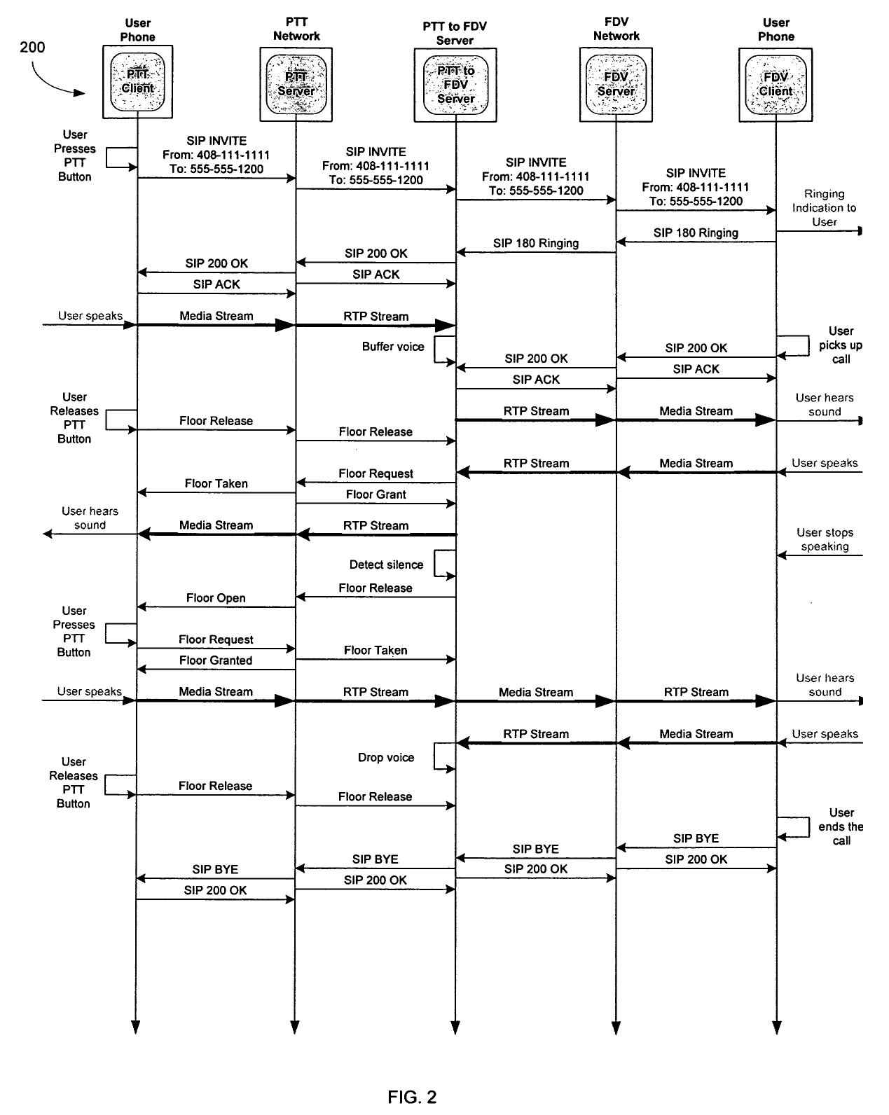

Referring now to FIG. 2, an exemplary call flow involving interactions between a user, a PTT to FDV server, and a FDV user is provided. Exemplary call flow 200 uses SIP as the PTT call setup protocol between PTT client 105 and PTT to FDV server component 130. Additionally, call flow 200 uses SIP as the FDV call setup protocol between FDV client 155 and PTT to FDV server component 130. However, as understood by one of ordinary skill in the art, this disclosure is not limited to the use of SIP such that other PTT and FDV protocols may be used with PTT to FDV system 100.

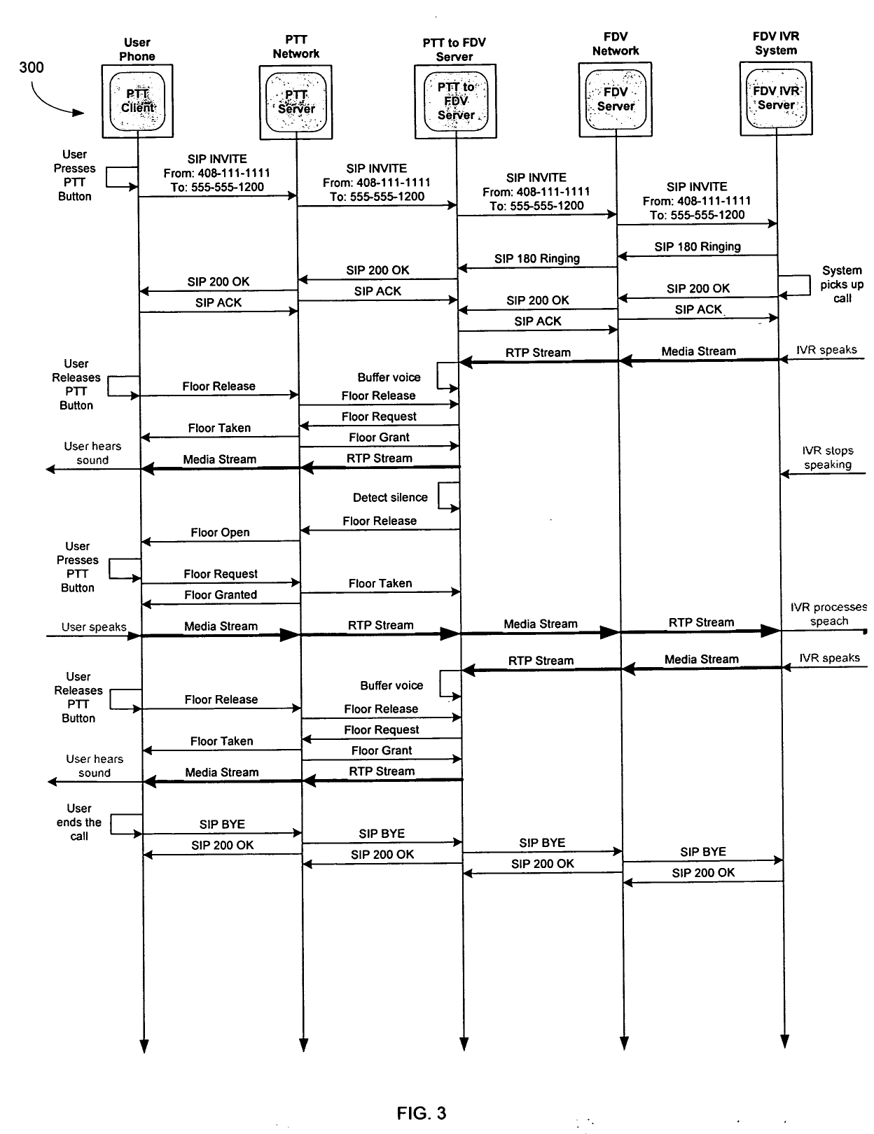

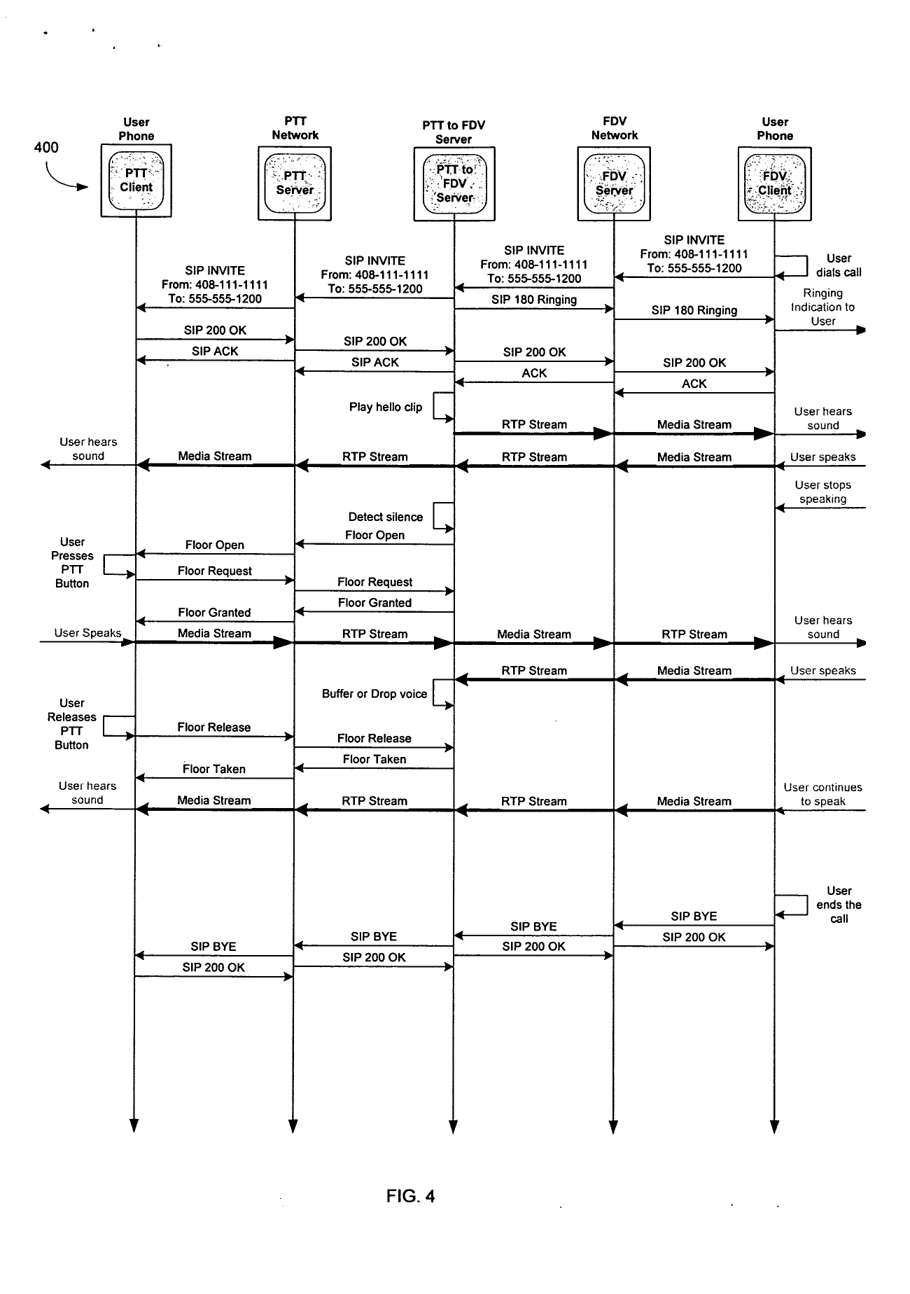

Referring now to FIG. 3, another exemplary call flow involving interactions between a PTT user, a PTT to FDV server, and a FDV IVR system is provided. Exemplary call flow 300 uses SIP as the PTT call setup protocol between PTT client 105 and PTT to FDV server component 130. Additionally, call flow 300 uses SIP as the FDV call setup protocol between FDV client 155 and PTT to FDV server component 130. However, as understood by one of ordinary skill in the art, this disclosure is not limited to the use of SIP such that other PTT and FDV protocols may be used with PTT to FDV system 100.

Referring now to FIG. 4, another exemplary call flow involving interactions between a FDV user, a PTT to FDV server, and a PTT user is provided. Exemplary call flow 400 uses SIP as the FDV call setup protocol between FDV client 155 and PTT to FDV server component 130. Additionally, call flow 400 uses SIP as the PTT call setup protocol between PTT user 105 and PTT to FDV server component 130. However, as understood by one of ordinary skill in the art, this disclosure is not limited to the use of SIP such that other PTT and FDV protocols may be used with PTT to FDV system 100.

It should be understood by one of ordinary skill in the art that additional components may be included in PTT to FDV system 100 shown in FIG. 1 without deviating from the principles and embodiments of the present invention.

The foregoing descriptions of specific embodiments and best mode of the present invention have been presented for purposes of illustration and description only. They are not intended to be exhaustive or to limit the invention to the precise forms disclosed. Specific features of the invention are shown in some drawings and not in others, for purposes of convenience only, and any feature may be combined with other features in accordance with the invention. Steps of the described processes may be reordered or combined, and other steps may be included. The embodiments were chosen and described in order to best explain the principles of the invention and its practical application, to thereby enable others skilled in the art to best utilize the invention and various embodiments with various modifications as are suited to the particular use contemplated. Further variations of the invention will be apparent to one skilled in the art in light of this disclosure and such variations are intended to fall within the scope of the appended claims and their equivalents. The publications referenced above are incorporated herein by reference in their entireties.

What is claimed is:

1. A system for providing communication between a user on a PTT communication appliance equipped to connect to a PTT network and a user on an full-duplex communications network, the system comprising:
a server for connecting the user on the PTT network to the user on the full-duplex network and for providing full-duplex communication between the user on the PTT network and the user on the full-duplex network without requiring change in user behavior, unnecessary speech cutoff and technology modifications on either network;
an interface for communication between the server and the PTT network; and
an interface for communication between the server and the FDV network.

2. The system of claim 1, wherein the PTT communication appliance comprises a PTT button for connecting to the PTT network.

3. The system of claim 2, further comprising an interface for communication between the communication appliance and the server.

4. The system of claim 3, wherein the server is configured to:
initiate and terminate PTT call signaling and media streams;
initiate and terminate FDV call signaling and media streams; and
maintain session information to allow communication be provided to the users.

5. A system for providing communication between a user on a PTT communication appliance equipped to connect to a PTT network and an information access tool available to users on a full-duplex communications network, the system comprising:
a server for connecting the user on the PTT network to the information access tool on the full-duplex network and for providing full-duplex communication between the user on the PTT network and the information access tool on the full-duplex network without requiring change in user behavior, unnecessary speech cutoff and technology modifications on either network;
an interface for communication between the server and the PTT network; and
an interface for communication between the server and the FDV network.

6. The system of claim 5, wherein the information access tool comprises an IVR system.

7. The system of claim 6, wherein the PTT communication appliance comprises a PTT button for connecting to the PTT network.

8. The system of claim 7, further comprising an interface for communication between the communication appliance and the server.

9. The system of claim 8, wherein the server is configured to:
initiate and terminate PTT call signaling and media streams;
initiate and terminate FDV call signaling and media streams; and
maintain session information to allow communication be provided to the user.

10. The system of claim 9, wherein the server is further configured to generate a DTMF tone to an IVR system upon the user pressing and releasing the PTT button.

11. A method for providing full-duplex communication capabilities to a user on a communication appliance equipped to connect to a PTT network, the method comprising connecting the user on the PTT network to a user on a full-duplex network without requiring change in user behavior, unnecessary speech cutoff and technology modifications on either network.

12. The method of claim 11, wherein connecting the user on the PTT network to a user on a full-duplex network comprises providing a server between the PTT network and the full-duplex network to perform the connection.

13. The method of claim 12, further comprising providing an interface for communication between the server and the PTT network.

14. The method of claim 12, further comprising providing an interface for communication between the server and full-duplex network.

15. A method for providing full-duplex communication capabilities to a user on a communication appliance equipped to connect to a PTT network, the method comprising connecting the user on the PTT network to an information access tool on a full-duplex network without requiring change in user behavior, unnecessary speech cutoff and technology modifications on either network.

16. The method of claim 15, wherein the information access tool comprises an IVR system.

17. The method of claim 16, wherein connecting the user on the PTT network to an information access tool on a full-duplex network comprises providing a server between the PTT network and the full-duplex network to perform the connection.

18. The method of claim 17, further comprising providing an interface for communication between the server and the PTT network.

19. The method of claim 17, further comprising providing an interface for communication between the server and full-duplex network.

20. An information server for providing full-duplex communication capabilities to a user on a communication appliance equipped to connect to a PTT network, the server configured to connect the user on the PTT network to a user on a full-duplex network without requiring change in user behavior, unnecessary speech cutoff and technology modifications on either network.

21. The information server of claim 20, wherein the server is further configured to:
initiate and terminate PTT call signaling and media streams;
initiate and terminate FDV call signaling and media streams; and
maintain session information to allow communication be provided to the users.

22. An information server for providing full-duplex communication capabilities to a user on a communication appliance equipped to connect to a PTT network, the server configured to connect the user on the PTT network to an information access tool on a full-duplex network without requiring change in user behavior, unnecessary speech cutoff and technology modifications on either network.

23. The information server of claim 22, wherein the information access tool comprises an IVR system.

24. The information server of claim 23, wherein the server is further configured to:
initiate and terminate PTT call signaling and media streams;
initiate and terminate FDV call signaling and media streams; and
maintain session information to allow communication be provided to the user.

25. The information server of claim 24, wherein the server is further configured to generate a DTMF tone to the IVR system upon the user pressing and releasing the PTT button.
